(19) United States
(12) Patent Application Publication
(10) Pub. No.: US 2026/0080162 A1
(43) Pub. Date: Mar. 19, 2026

(54) GENERATIVE ARTIFICIAL INTELLIGENCE SUMMARIZATION SERVICE

(71) Applicant: Salesforce, Inc., San Francisco, CA (US)

(72) Inventors: Raveesh RAINA, Toronto (CA); Frank LAMA, Toronto (CA); Brian COLE, Hastings, MN (US)

(73) Assignee: Salesforce, Inc., San Francisco, CA (US)

(21) Appl. No.: 19/039,390

(22) Filed: Jan. 28, 2025

Related U.S. Application Data
(60) Provisional application No. 63/695,236, filed on Sep. 16, 2024.

(51) Int. Cl. G06F 40/20; G06F 9/451; G06F 40/186

(52) U.S. Cl. CPC G06F 40/20; G06F 9/451; G06F 40/186

(57) ABSTRACT

The present disclosure provides a summarization service that delivers pre-generated prompt templates to users of a multi-tenant system. The summarization service displays prompt template options to a tenant in a multi-tenant system based on prompt template identifiers contained in a data object selected by the tenant and corresponding to a use case. In response to selection of one of the prompt template options by the tenant, the summarization service retrieves a prompt template from a prompt template database. The summarization service then integrates data from the data object into the prompt template to produce a generative AI prompt. The summarization service obtains an output from a generative AI system based on the generative AI prompt.

### CROSS-REFERENCE TO RELATED APPLICATIONS

The present application claims benefit to U.S. Provisional Patent Application No. 63/695,236, filed September 16, 2024, which is hereby incorporated by reference in its entirety.

### BACKGROUND

Large Language Models (LLMs) are machine learning (ML) models that can comprehend and generate human language text and other generative outputs based on a large data training set. LLMs are starting to become integrated into a wide variety of fields, such as research, agent response, healthcare, translation, content creation, and a wide array of business applications.

In order to cause an LLM to produce responsive action, it is often necessary to write a prompt to the LLM. This prompt is essentially an instruction to the LLM. Different LLMs may use different prompts, and one prompt may not necessarily be interchangeable with another. Prompt engineering has proven challenging for companies because it can be difficult to add the context necessary for the task without manually entering the contextual data into the LLM. However, manually entering contextual data into an LLM creates privacy and security risks for both the customer and the company. This has given rise to new professions, such as prompt engineer, who may be a primary resource for prompting LLMs to generate desired responses. With the increased integration of LLMs in a wide variety of user interfaces, it is becoming increasingly critical to provide a user-friendly LLM prompt generator that does not require a prompt engineer to utilize.

One or more aspects of the present disclosure relate to a service that acts as an intermediary between a user and a generative artificial intelligence system. The service may provide prompt templates to a user and generate a prompt based on a prompt template selected by the user.

### BRIEF DESCRIPTION OF THE DRAWINGS

The accompanying drawings are incorporated herein and form a part of the specification. The following figures use like reference numbers to refer to like elements. Although the following figures depict various embodiments, alternative implementations are within the spirit and scope of the appended claims. In the drawings:

FIG. 1 shows an example environment, according to some example implementations.

FIG. 2 shows an example summary generation environment, according to some example implementations.

FIG. 3 shows an example summary generation service, according to some example implementations.

FIG. 4 shows an example prompt, according to some example implementations.

FIGS. 5A and 5B show an example user interfaces for generating and editing a data summary, according to some example implementations.

FIG. 6 shows a method for generating a data summary, according to some example implementations.

FIG. 7 shows a computer system, according to some example implementations.

In the drawings, like reference numbers generally indicate identical or similar elements. Additionally, generally, the left-most digit(s) of a reference number identifies the drawing in which the reference number first appears.

### DETAILED DESCRIPTION OF THE INVENTION

Provided herein are system, apparatus, device, method and/or computer program product aspects, and/or combinations and sub-combinations thereof, for providing a generative artificial intelligence service to a user though an integrated module.

Many different business computer environments, and in particular those that serve customer or subscriber needs, may include one or more machine learning (ML) models that can be used by customers to carry out various tasks. For example, wealth management advisors, often need to review and digest large amounts of client data before meetings. This time consuming task can be made easier through the use of generative artificial intelligence (AI) systems, such as large language models (LLM’s). For example, LLM’s can review and summarize elements of a client profile, such as financial accounts, financial plans, goals, client engagement, and open accounts.

Notably, while there has been significant movement in the business industry toward the use of LLMs in their day-to-day operations, most systems are very limited in their capability to integrate LLMs in a user friendly and intuitive manner. AI powered workflow experiences are only useful to a user when they are fully integrated within a system. However, in order to generate an output from an LLM, a prompt must be provided to the LLM. A prompt is a combination of instructions, guidance, and requirements combined with contextual data to be transformed by the LLM. Prompt generation provides specific challenges to a business because the majority of users of a system do not know how to create effective prompt instructions. Therefore, there is a need in the industry for a service that provides pre-generated and industry specific prompts to users.

The present disclosure provides a summarization service that delivers pre-generated prompt templates to users of an integrated AI system. The summarization service displays prompt template options to a user based on prompt template identifiers contained in a data object selected by the user. The prompt template identifiers are specific to an industry identifier assigned to the data object. In response to selection of one of the prompt template options by the user, the summarization service retrieves a prompt template from a prompt template database. The summarization service then integrates data from the data object into the prompt template to produce a generative AI prompt. The summarization service obtains an output from a generative AI system based on the generative AI prompt.

In some examples, the prompt templates are generated for a specific industry, such as finance, healthcare, education, and the like. These industry-specific prompt templates can prompt a LLM more effectively than generalized prompt templates while remaining accessible to non-technical users. Industry specific prompt templates can allow effective prompt templates to be delivered automatically to a plurality of users at scale. A user may receive the prompt templates via a subscription to a package of industry-specific tools or to a package of generative AI tools. Additionally, an organization may subscribe to the package of industry specific tools or the package of generative AI tools and disseminate these tools to users within their organization.

In some examples, the summarization service can be integrated into a multi-tenant system. A multi-tenant system can be configured to serve multiple organizations, each as a tenant on the system. The system can include multiple information technology infrastructure clusters, known as a points of deployment (“pods”), configured to provide redundancy, load balancing, and high availability. Each pod can include hardware servers, software, and networking equipment collocated within a geographical area, and can host multiple organizations. The software can include, as examples, an application server, database server, a database, a file system, and a search system. In implementations as described herein, the software can further include a generative AI gateway, such as an LLM gateway, configured to provide prompt inputs to a generative AI model, such as an LLM. The prompts can be textual or can be of other modalities, such as image prompts, audio prompts, or video prompts. The LLM can be hosted by the multi-tenant system, e.g., on one of its pods, or can be hosted outside of the system and accessed via the internet. The generative AI gateway can be configured to interface with one or more different generative AI models, abstracting away the differences in inputs expected by the different models and the outputs provided by the different models back to the system. Each pod can host one or more environments for each tenant on the pod. The environments can include, as examples, one or more of a production or “live” environment, a development environment, a testing environment, an integration environment, and a training environment.

One or more tenant users of each environment may be designated as organization administrators (“admins”), bestowing administrative privileges them within the respective environment running on the pod. Admins can be authorized, via their permissions levels, to configure different generative AI prompt templates for different scenarios.

The multi-tenant environment can incorporate one or more user devices. The one or more user devices can remotely interact with the multi-tenant environment (e.g., with a pod) via a wireless communications connection, e.g., a radio frequency connection such as a cellular telephone communication connection or Wi-Fi, using a web browser interface or a mobile device application (“app”) interface, as examples. The multi-tenant environment can intermittently or periodically transmit data to one or more of the mobile devices for storage thereon.

In various implementations, the models, modules, and/or services described herein may be classification, predictive, generative, conversational, or another form of artificial intelligence (AI) technology, such as AI model(s), agents, etc., implementing one or more forms of machine learning, a neural network, statistical modeling, deep learning, automation, natural language processing, or other similar technology. The AI technology may be included as part of a network or system comprising a hardware-or software-based framework for training, processing, fine-tuning, or performing any other implementation steps. Furthermore, the AI technology may include a hardware-or software-based framework that performs one or more functions, such as retrieving, generating, accessing, transmitting, etc. The AI technology may be implemented by a computer including a register coupled with a processor or a central processing unit (CPU).

Moreover, the AI technology may be trained or fine-tuned using supervised, unsupervised, or other AI training techniques. In various implementations, the AI technology may be trained or fine-tuned using a set of general datasets or a set of datasets directed to a particular field or task. Additionally or alternatively, the AI technology may be intermittently updated at a set interval or in real time based on resulting output or additional data to further train the AI technology. The AI technology may offer a variety of capabilities including text, audio, image, and other content generation, translation, summarization, classification, prediction, recommendation, time-series forecasting, searching, matching, pairing, and more. These capabilities may be provided in the form of output produced by the AI technology in response to a particular prompt or other input. Furthermore, the AI technology may implement Retrieval-Augmented Generation (RAG) or other techniques after training or fine-tuning by accessing a set of documents or knowledge base directed to a particular field or website other than the training or fine-tuning data to influence the AI technology’s output with the set of documents or knowledge base.

To further guide and train output of the AI technology, a plurality of input prompts may be provided to the AI technology for the purpose of eliciting particular responses. In various implementations, the plurality of input prompts may correspond to the particular field or task to which the AI technology is trained. Additionally, the AI technology may be implemented along with a plurality of additional AI technologies. For example, a first AI model may produce a first output, which is used as input for a second AI model to produce a second output. These AI technologies may be used in succession of one another, in parallel with another or a combination of both. Furthermore, the AI technologies may be merged in a variety of implementations, for example, by bagging, boosting, stacking, etc. the AI technologies.

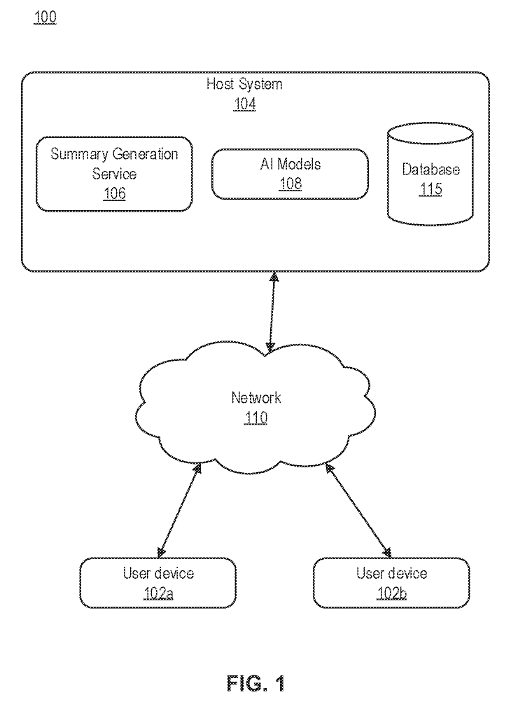

FIG. 1 shows a block diagram of example environment 100 in which example systems and/or methods may be implemented. Environment 100 may include user devices 102a and 102b, which may take the form of a mobile device, a personal computer, or other electronics capable of communicating over a network, such as a smartphone, tablet, computer, personal digital assistant, smart watch, or the like. The environment may also include a host system 104. In some aspects, host system 104 may include all interfaces and functionality in support of a subscriber, as well as internal systems. Included within host system 104 are a summary generation service 106 and one or more AI models 108.

As shown in FIG. 1, user devices 102a and 102b may connect to the host system 104, summary generation service 106, and one or more AI models 108 over a network 110. In some aspects, network 110 may comprise any type of computer or telecommunications network capable of communicating data, including but not limited to a local area network, a wide-area network (e.g., the Internet), or any combination thereof. The network may include wired and/or wireless segments. In some aspects, network 110 may be a secure network. In some aspects, one or more of user devices 102a and 102b may reside within network 110.

Host system 104 may have access to a plurality of databases or libraries, including a database 115. Database 115 may comprise a multi-tenant database, which holds customer data for multiple subscribers. The customer data may relate to a specific company (subscriber) accessing the service, its employees, or business accounts associated with the company or its employees, such as one or more sales accounts. Database 115 may have built in functionalities that allow subscribers to access only their own data. Database 115 may be located within the host system, separate from the host system but still local, or accessible by the host system via network 110.

During operation, a user of user device 102a or 102b may access summary generation service 106 and/or one or more AI models 108 via network 110. The user may generate a summary of client data held in database 115 using summary generation service 106. In some examples, summary generation services 106 generates a summary using one or more AI models 108.

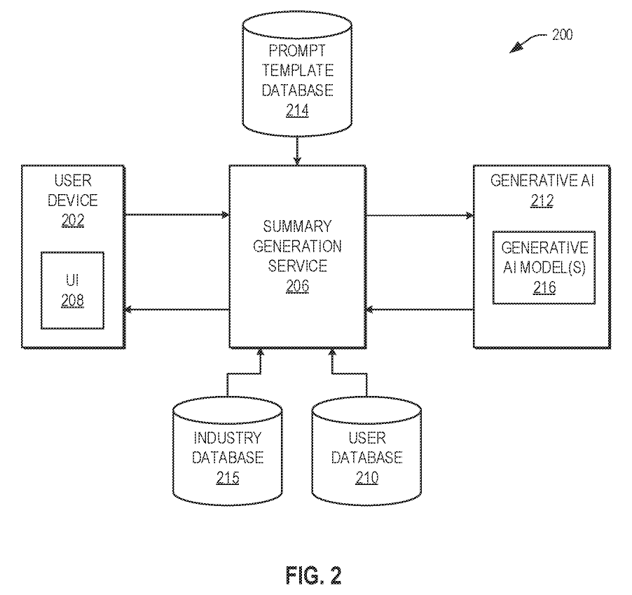

FIG. 2 shows an example summary generation environment 200, according to some example implementations. Environment 200 may contain a user device 202 and a summary generation service 206. Environment 200 can, in some examples, operate within the context of a multi-tenant system or environment as described above. The user device 202 can be any computing device configured to provide a user interface (UI) 208 and configured with communication capabilities to communicate with other computing devices. For example, user device 202 can be a personal computer or mobile device such as a smartphone, tablet, or smart watch.

UI 208 can display data associated with a data object (e.g., client profile). Data associated with the data object can be stored in an industry database 215 and/or a user database 210. In some examples, industry database 215 is a multi-tenant system designed to integrate with cloud-based software products. User database 210 can include a company specific database that is hosted at a client site. Data contained in user database 210 can surface with a cloud-based database (not shown). UI 208 may also display an interface that allows a user to access software products, such as summary generation service 206, that perform operations on data contained within industry database 215 and/or user database 210.

Summary generation service 206 can be configured to summarize data associated with the data object by generating and sending a prompt to a generative AI 212. The prompt can be chosen by a user. For example, summary generation service 206 can display one or more prompt types to a user via UI 208. UI 208 can display a navigation system that allows a user to select a prompt type. When a user selects a prompt type, a summarization request can be sent from user device 202 to summary generation service 206. Summary generation service 206 can retrieve a prompt template from prompt template database 214 based on the selected prompt type. Then, a prompt can be generated, for example, by hydrating the prompt template with user data stored in industry database 215 and/or user database 210.

The prompt can then be sent to generative AI 212. In some examples, the generative AI 212 can be executed using the same one or more computing devices used to execute summary generation service 206, in which case the prompt can be transmitted from summary generation service 206 to the generative AI 212 without a network as an intermediary. In other examples, the generative AI 212 is provided on one or more separate computer systems from the one or more computer systems used to run the summary generation service 206, and can connect to the summary generation service 206 via the internet. For example, the generative AI 212 may be provided as a cloud service.

Examples of the generative AI 212 can include Google Gemini 1.5 Pro, OpenAI GPT-4 or GPT-4o, and Anthropic Claude 3.5. GPT-4 is based on eight models with 220 billion parameters each, for a total of about 1.76 trillion parameters, connected by a mixture of experts (MoE). GPT-4o has a token limit of 128,000 tokens. Gemini 1.5 Pro has 1.5 trillion parameters and a token limit of 1,000,000 tokens. A token limit may dictate the combined size of both an input (including prompt and context data) and an output of the generative AI 212.

The generative AI 212 can include one or more generative AI models 216. Where more than one generative AI model 216 is used, the models can each accomplish different AI functions and/or can work in concert with each other to produce generative AI outputs. For example, one or more of the models 216 can comprise an LLM. The form of the generative AI outputs can be of any modality, e.g., textual data, audio data, video data, pictorial data, audiovisual data, code data, or interactive or game data, as examples. In some examples, the generative AI 212 can be trained on data from industry database 215, such that the model 216 knows and understands this data, and is capable of directly generating a summary based on industry specific data. In other examples, the generative AI 212 is not trained on data from industry database 215, but can be provided this data as context data.

The generative AI 212 can use a prompt received from summary generation service 206 to generate a summary of a specified set of data. The generated summary can be sent back to summarization service 206, and then returned to user device 202 where it displayed via UI 208. A user can then edit and save the generated summary.

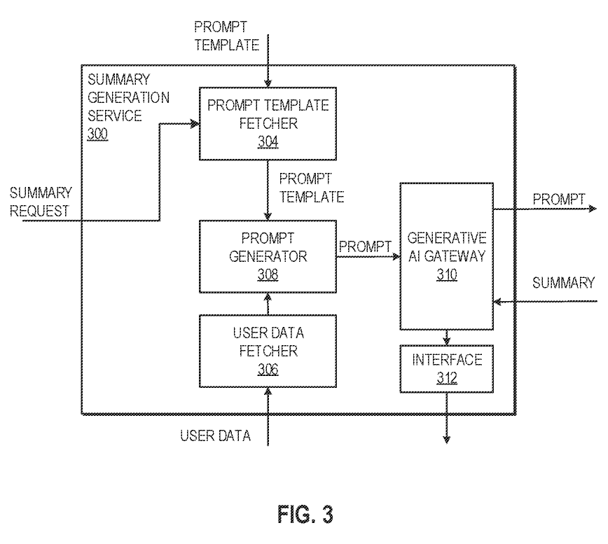

FIG. 3 shows an example summary generation service 300, according to some example implementations. The summary generation service 300 can receive a summary request from a user, e.g., from user device 202.

The summary generation service 300 can include a prompt template fetcher 304 configured to generate and execute an appropriate query to fetch an AI prompt template from prompt template database 214. Prompt template fetcher 304 may generate the query based on the summary request received from the user.

The summary generation service 300 can further include a user data fetcher 306 that can be configured to create and execute an appropriate query to search a database, such as user database 210 and/or industry database 215, to gather data for generating a summary.

In some examples, summary generation service 300 of FIG. 3 can further include a prompt generator 308. The prompt generator 308 can be configured to convert a prompt template provided by the prompt template fetcher 304 into a prompt based on data provided by the user data fetcher 306 and/or from a generative AI, such as generative AI 212 in FIG. 2, as described below.

The summary generation service 300 can further include a generative AI gateway 310 (e.g., an LLM gateway). The generative AI gateway 310 can include one or more application programming interfaces (APIs) for one or more respective generative AIs, thus abstracting away implementation details for the different generative AIs from the perspective of the rest of the summary generation service 300. The generative AI gateway 310 can integrate with different generative AI models and providers, exposing them as, in effect, a unified API from the perspective of any application that may use a generative AI. The use of the generative AI gateway 310 advantageously permits easier and more seamless swapping-out of one generative AI for another as the generative AI to be used by the summary generation service 300. In addition to offering this horizontal scalability, the generative AI gateway can include a trust layer that can perform masking of personally identifiable information (PII masking), payment card information (PCI masking), and protected health information (PHI masking) that may be provided in a generative AI prompt before that information is transmitted to a third-party generative AI, thus preventing security leaks of sensitive information. Still further, the generative AI gateway 310 can handle transformation of a prompt as a normalized payload into a vendor-specific request payload. Still further, the generative AI gateway can transmit the request payload using the appropriate security credentials, which may be specific to the generative AI selected to be used, the user or user organization, or both. In some examples, the generative AI gateway 310 is provided as a separate service, e.g., a micro-service, e.g., a cloud-based service.

Having performed its various functions as described above, which may vary in different implementations, the generative AI gateway 310 can transmit a prompt as an input to a selected generative AI and can receive, in return, an output of the selected generative AI. In accordance with instructions that may be provided in the AI prompt, the generative AI output can, for example, take the form of a formatted or unformatted prose text output that can include, in some instances, one or more numbered or bulleted lists and/or one or more section headings. In accordance with instructions that may be provided in the AI prompt, the generative AI output can provide a summary of data associated with a data object. For example, if the data object is a client file for a wealth management services client, the generative AI output may contain a summary of the client’s accounts, engagement with a service, financial plans, financial goals, and the like. The summary generation service 300 can further include an interface 312, which provides a generated summary as an output of the summary generation service 300 to user device 202.

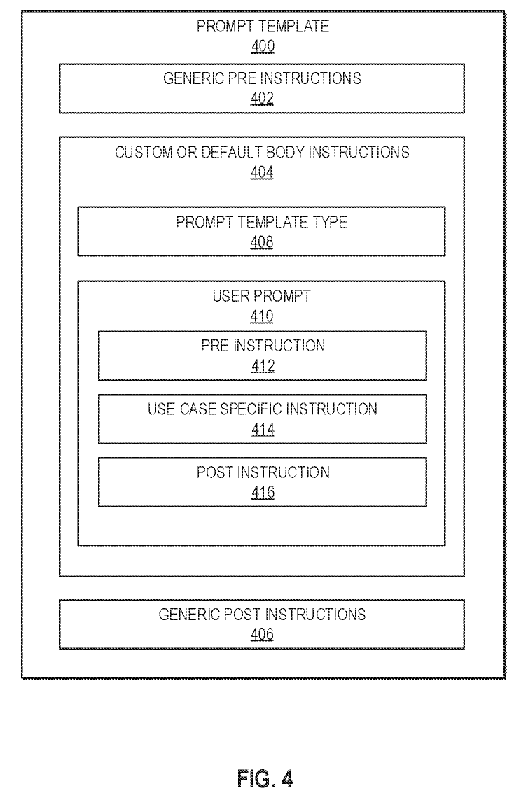

FIG. 4 shows an example prompt template 400, which can include generic pre instructions 402, custom or default body instructions 404, and generic post instructions 406, each of which comprise natural-language text that can include data, e.g., numerical data, tabular data, or other data. Slots for the data can be provided in the template 400 as merge fields. The generic pre instructions 402 and generic post instructions 406 can be written to apply for a wide variety of prompts to a generative AI. For example, the generic pre instructions 402 and generic post instructions 406 can contain information about a multi-tenant environment system policy. The system policy information in the generic post instructions 406 can be all or partially different from the system policy information in the generic pre instructions 402, or can be all or partially the same. Repetition of some of the system policy information after the user prompt can reinforce the system policy information as processed by the generative AI 212. For example, one or more directives specifying the language, tone and style can be repeated in the generic post instructions 406 to better ensure that these directives are followed by the generative AI 212. The body instructions 404 can be written specifically to generate a data summary for a specific industry. In some examples, default body instructions 404 can be supplied, which can be modified or re-written by an administrator, in the context of a multi-tenant environment. The body instructions 404 can include, for a given prompt template type 408, a user prompt 410 that can include a pre instruction 412, a use case specific instruction 414, and a post instruction 416. In some examples, some of the fields, such as the post instruction 416, can be empty (omitted).

For example, in the context of a prompt template 400 for generating a summary of client data in the financial services industry, the pre instruction 412 can include text such as, “You are a wealth management advisor working for a premier financial services institution and manage a portfolio of ultra-high net worth clients. You are tasks with creating a short summary of Input:AccountName to be used in preparation of an upcoming meeting you have with them. You must treat equally any individuals or persons from different socioeconomic statuses, sexual orientations, religions, races, physical appearances, nationalities, gender identities, disabilities, and ages. When you do not have sufficient information, you must choose the unknown option, rather than making assumptions based on any stereotypes.”

For example, in the context of a prompt template 400 for generating a summary of client data in the financial services industry, the use case specific instruction 414 can include text such as: “Follow the instructions precisely, do not add any information not provided. Use clear, concise, and straightforward language using the active voice and strictly avoiding the use of filler words, phrases, and redundant language. Keep the emotion of the summary relaxed. Create a two paragraph summary of their financial accounts using the following information: Flow:clientsummary_GetFinancialAccounts. The title of this paragraph should be Financial Accounts Overview. Create a one paragraph summary of their financial plans using the following information: Flow:clientsummary_GetFinancialPlans. The title of this paragraph should be Financial Plans. Create a one paragraph summary of their financial goals using the following information: Flow:clientsummary_GetFinancialGoal. If a plan is associated with the goal, include this in your summary. The title of this paragraph should be Financial Goals. Create a one paragraph summary of their top five financial holdings with profit and top five financial holding with a loss using the following information: Flow:clientsummary_GetFinancialHoldings. The title of this paragraph should be Financial Holdings Performance. Use data in Flow:clientsummary_GetOpenCases to summarize any open cases. Mention how many open cases there are wand what the case issues are. Summarize each case, grouping by priority and then each on its own bullet point no longer than 500 characters. The title of this paragraph should be Servicing Requests. Conclude the summary with recommended action items to show more value to the customer and keep them better engaged with you. The title of this paragraph should be Possible Next Steps and Action Items. Each paragraph should start and end with an emoji. Each paragraph title should be given a unique emoji corresponding to the content of the paragraph. Now create the summary.”

In some examples, prompt template 400 can be grounded using multiple data resources, including data contained in industry database 215 and/or user database 210. Grounding is a process though which domain specific knowledge and user information are added to a prompt to give the model the context it needs to perform more accurately. In the example provided above, a prompt for generating a wealth management client summary is simultaneously grounded using multiple data flows contained within a client profile, including financial account data, financial plan data, financial goals, financial holdings, and open cases.

Prompt template 400 can be configured for use by multiple users in a multi-tenant system. Prompt template 400 can also be customized by a system administrator. For example, the prompt template can be edited to reference data in an onsite database (e.g., user database 210) or, instructions within the prompt can be edited.

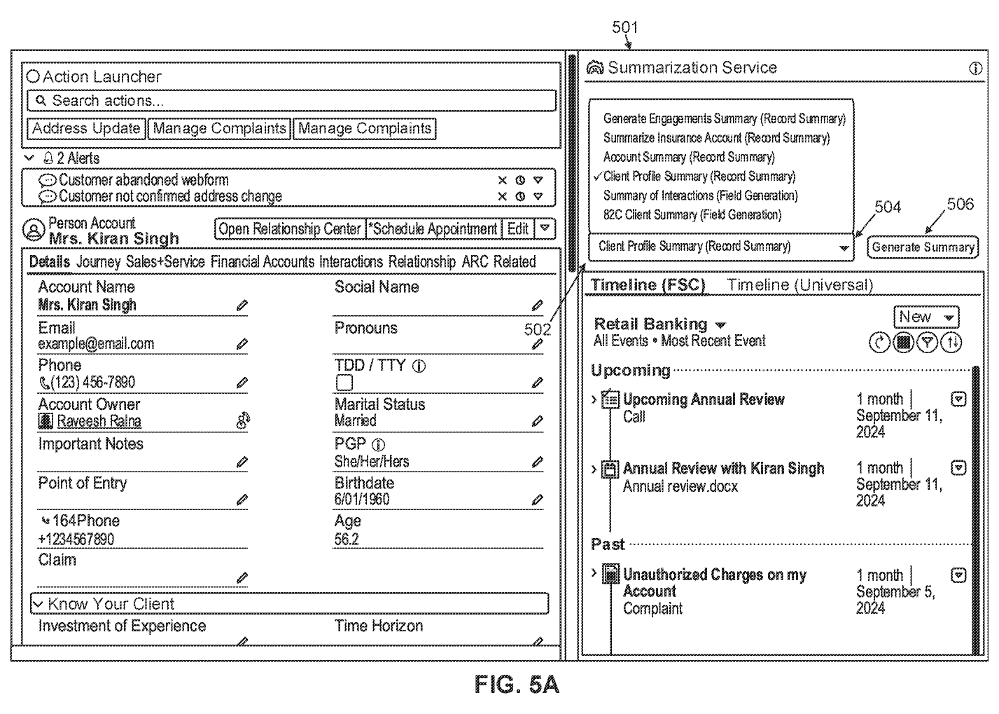

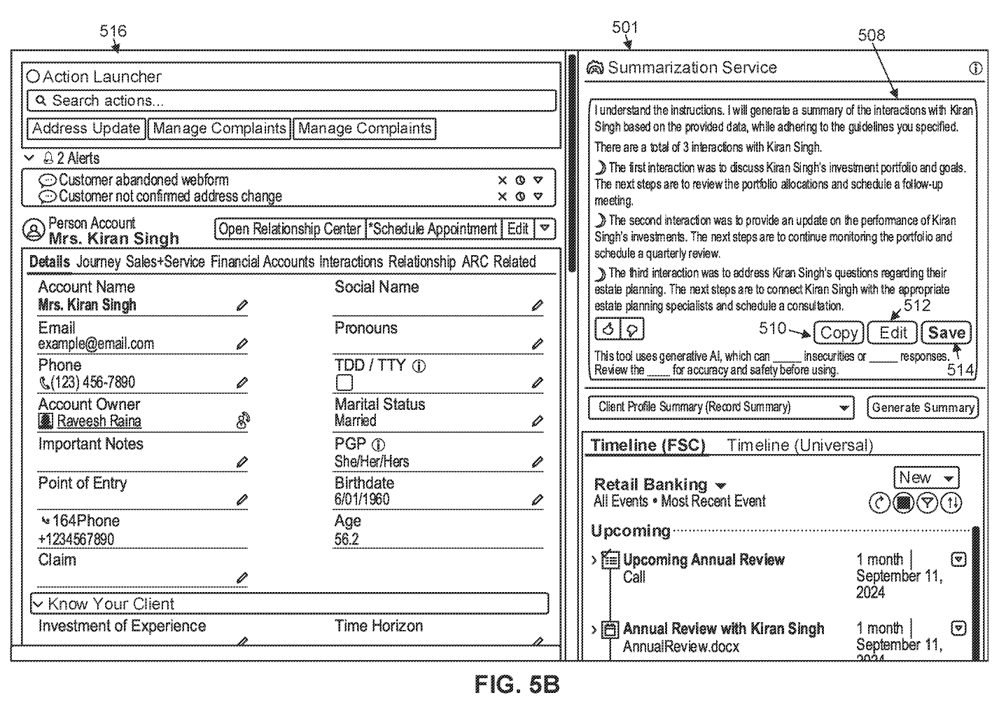

FIGS. 5A and 5B shows example user interfaces (UI’s) for generating and editing data summaries, according to some example implementations. In FIG. 5A, a UI can contain a sidebar 501 containing a list box 502. When a user clicks a down arrow 504 in list box 502, the UI may provide a plurality of options that describe the prompt templates available for a specific use case (e.g., summarizing wealth management client data). The user can select (e.g., click) an option within list box 502. After the user selects an option, the user may click an icon button 506 to request a data summary. In other examples, the UI may provide list box 502 without providing icon button 506, and the request may be initiated when the user selects an option. Once the user selects (e.g., clicks) an option, the summarization service can choose a prompt template from prompt template database 214 based on the type of prompt the user selected.

FIG. 5B shows an example UI for editing and saving a summary generated by a generative AI. The summary can be displayed in a text box 508 located in sidebar 501. A user can click icon buttons 510, 512, or 514 to copy, edit, or save the summary, respectively. The summary can be edited inside sidebar 501, or can be enlarged in a main portion 516 of the UI (not shown).

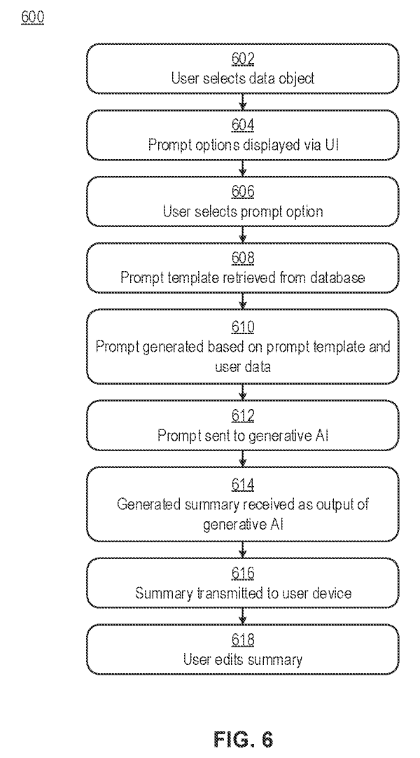

FIG. 6 shows a flowchart of a method 600 for generating a data summary, according to some example implementations. Method 600 can be performed by processing logic that can comprise hardware (e.g., circuitry, dedicated logic, programmable logic, microcode, etc.), software (e.g., instructions on a processing device), or a combination thereof. It is to be appreciated that not all steps may be needed to perform the disclosure provided herein. Furthermore, some of the steps can be performed simultaneously or in a different order than shown in FIG. 6, as will be understood by a person of ordinary skill in the art. Method 600 is described herein in reference to FIGS. 1-5 but is not necessarily limited to those embodiments.

At step 602, a user may select a data object (e.g., client profile) via UI 208. In some examples, the data object can specify one or more prompt template identifiers that correspond to prompt templates stored in prompt template database 214. The specification of one or more prompt template identifiers in the data object can ensure that a correct prompt template is selected that is useful for processing information specific to the data object. In some aspects, the prompt template identifiers can be specific to an industry identifier assigned to the data object. Additionally or alternatively, the prompt template identifiers (or prompt templates) can be specified within a software package. The software package can include a plurality of services, such as summary generation service 206 that perform functions on data within user database 210 and/or industry database 215. The software package may be industry-specific. The specification of prompt template identifiers or prompt templates within a software package allows for automated delivery of prompt templates to a plurality of users.

At step 604, one or more prompt options can be displayed to a user via UI 208. The prompt options can correspond to the prompt template identifiers (or prompt templates) specified in the data object or software package. For example, if the data object is a client profile, the prompt options can include: summarizing client accounts, summarizing interactions, and/or summarizing a client profile.

At step 606, the user can select a prompt option. At step 608, a prompt template can be retrieved based on the prompt option selected by the user. The prompt template can be retrieved from a database, e.g., prompt template database 214 using prompt template fetcher 304.

At step 610, a prompt can be generated based on the prompt template and the data object. For example, the prompt template can be grounded with data from the data object. In some examples, the prompt is grounded with data from multiple data flows. For example, if the data object is a wealth management client account, data flows can include financial accounts, financial plans, financial goals, financial holdings, and open cases.

At step 612, the prompt can be provided to a generative AI, such as generative AI 212. The prompt can be provided via a generative AI gateway, e.g., generative AI gateway 310. The generative AI can generate the requested summary.

At step 614, the generated summary is received as output of the generative AI and, at step 616, is transmitted to a user device, e.g., user device 202 in FIG. 2. At step 618 the user can access, edit, and save the generated summary via UI 208.

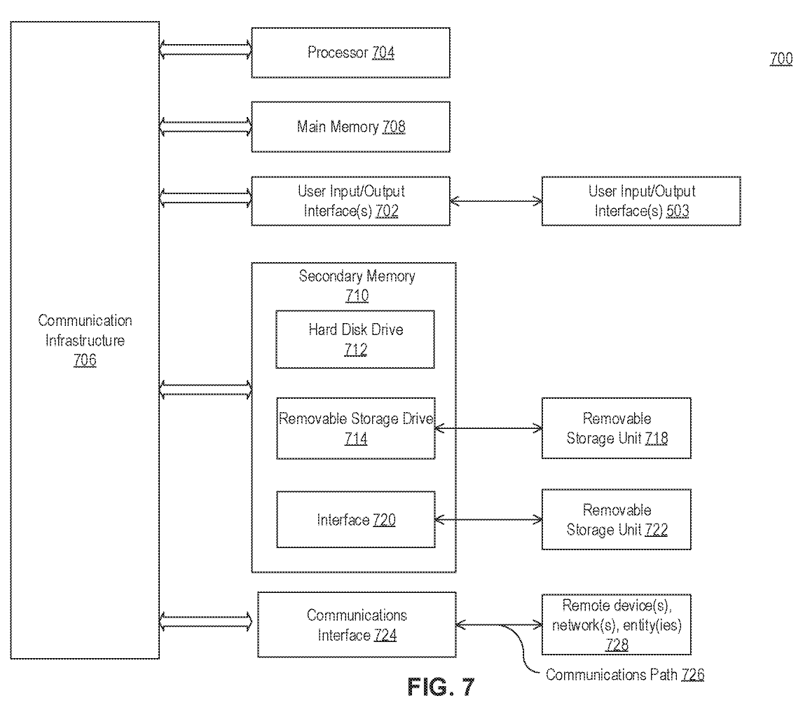

Various embodiments may be implemented, for example, using one or more well-known computer systems, such as computer system 700 shown in FIG. 7. One or more computer systems 700 may be used, for example, to implement any of the embodiments discussed herein, as well and combinations and sub-combinations thereof.

Computer system 700 may include one or more processors (also called central processing units, or CPUs), such as a processor 704. Processor 704 may be connected to a communication infrastructure or bus 706.

Computer system 700 may also include user input/output device(s) 703, such as monitors, keyboards, pointing devices, etc., which may communicate with communication infrastructure 706 through user input/output interface(s) 702.

One or more of processors 704 may be a graphics processing unit (GPU). In an embodiment, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 700 may also include a main or primary memory 808, such as random access memory (RAM). Main memory 708 may include one or more levels of cache. Main memory 708 may have stored therein control logic (i.e., computer software) and/or data.

Computer system 700 may also include one or more secondary storage devices or memory 710. Secondary memory 710 may include, for example, a hard disk drive 712 and/or a removable storage device or drive 714. Removable storage drive 714 may be a floppy disk drive, a magnetic tape drive, a compact disk drive, an optical storage device, tape backup device, and/or any other storage device/drive.

Removable storage drive 714 may interact with a removable storage unit 718. Removable storage unit 718 may include a computer usable or readable storage device having stored thereon computer software (control logic) and/or data. Removable storage unit 718 may be a floppy disk, magnetic tape, compact disk, DVD, optical storage disk, and/ any other computer data storage device. Removable storage drive 714 may read from and/or write to removable storage unit 718.

Secondary memory 710 may include other means, devices, components, instrumentalities or other approaches for allowing computer programs and/or other instructions and/or data to be accessed by computer system 700. Such means, devices, components, instrumentalities or other approaches may include, for example, a removable storage unit 722 and an interface 720. Examples of the removable storage unit 722 and the interface 720 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 700 may further include a communication or network interface 724. Communication interface 724 may enable computer system 700 to communicate and interact with any combination of external devices, external networks, external entities, etc. (individually and collectively referenced by reference number 728). For example, communication interface 724 may allow computer system 700 to communicate with external or remote devices 728 over communications path 726, which may be wired and/or wireless (or a combination thereof), and which may include any combination of LANs, WANs, the Internet, etc. Control logic and/or data may be transmitted to and from computer system 700 via communication path 726.

Computer system 700 may also be any of a personal digital assistant (PDA), desktop workstation, laptop or notebook computer, netbook, tablet, smart phone, smart watch or other wearable, appliance, part of the Internet-of-Things, and/or embedded system, to name a few non-limiting examples, or any combination thereof.

Computer system 700 may be a client or server, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (SaaS), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in computer system 700 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats or schemas may be used, either exclusively or in combination with known or open standards.

In some embodiments, a tangible, non-transitory apparatus or article of manufacture comprising a tangible, non-transitory computer useable or readable medium having control logic (software) stored thereon may also be referred to herein as a computer program product or program storage device. This includes, but is not limited to, computer system 700, main memory 708, secondary memory 710, and removable storage units 718 and 722, as well as tangible articles of manufacture embodying any combination of the foregoing. Such control logic, when executed by one or more data processing devices (such as computer system 700), may cause such data processing devices to operate as described herein.

Based on the teachings contained in this disclosure, it will be apparent to persons skilled in the relevant art(s) how to make and use embodiments of this disclosure using data processing devices, computer systems and/or computer architectures other than that shown in FIG. 7. In particular, embodiments can operate with software, hardware, and/or operating system implementations other than those described herein.

It is to be appreciated that the Detailed Description section, and not the Summary and Abstract sections, is intended to be used to interpret the claims. The Summary and Abstract sections may set forth one or more but not all exemplary embodiments of the present invention as contemplated by the inventor(s), and thus, are not intended to limit the present invention and the appended claims in any way.

The present invention has been described above with the aid of functional building blocks illustrating the implementation of specified functions and relationships thereof. The boundaries of these functional building blocks have been arbitrarily defined herein for the convenience of the description. Alternate boundaries can be defined so long as the specified functions and relationships thereof are appropriately performed.

The foregoing description of the specific embodiments will so fully reveal the general nature of the invention that others can, by applying knowledge within the skill of the art, readily modify and/or adapt for various applications such specific embodiments, without undue experimentation, without departing from the general concept of the present invention. Therefore, such adaptations and modifications are intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance.

The breadth and scope of the present invention should not be limited by any of the above-described exemplary embodiments, but should be defined only in accordance with the following claims and their equivalents.

What is claimed is:

1. A method, comprising:
displaying, by one or more computing devices, prompt template options to a tenant in a multi-tenant system based on prompt template identifiers contained in a data object selected by the tenant and corresponding to a use case;
retrieving, by the one or more computing devices, a prompt template from a prompt template database based on a selection of one of the prompt template options;
integrating, by the one or more computing devices, data from the data object into the prompt template to produce a generative artificial intelligence (AI) prompt; and
obtaining, by the one or more computing devices, an output from a generative AI system based on the generative AI prompt.

2. The method of claim 1, further comprising:
displaying, by one or more computing devices, the output via a user interface; and
receiving, by one or more computing devices, edits to the output from the tenant.

3. The method of claim 1, wherein the integrating comprises integrating data from multiple data flows within the data object into the prompt template.

4. The method of claim 1, wherein the prompt template identifiers are specified in an industry-specific package corresponding to the use case and subscribed to by the tenant.

5. The method of claim 1, further comprising displaying, by the one or more computing devices, a prompt template option for a prompt template that is customized for the tenant.

6. The method of claim 1, further comprising:
displaying, by the one or more computing devices, the prompt template options to an additional tenant in a multi-tenant system based on prompt template identifiers contained in an additional data object selected by the additional tenant;
retrieving, by the one or more computing devices, the prompt template from the prompt template database based on a selection of one of the prompt template options by the additional tenant;
integrating, by the one or more computing devices, data from the additional data object into the prompt template to produce an additional generative AI prompt; and
obtaining, by the one or more computing devices, an additional output from the generative AI system based on the generative AI prompt.

77 The method of claim 1, wherein the prompt template contains instructions for summarizing data contained within two data sources.

8. A system, comprising:
a memory; and
a processor, coupled to the memory and configured to:
display prompt template options to a tenant in a multi-tenant system based on prompt template identifiers contained in a data object selected by the tenant and corresponding to a use case;
retrieve a prompt template from a prompt template database based on a selection of one of the prompt template options;
integrate data from the data object into the prompt template to produce a generative artificial intelligence (AI) prompt; and
obtain an output from a generative AI system based on the generative AI prompt.

9. The system of claim 8, wherein the processor is further configured to:
display the output via a user interface; and
receive edits to the output from the tenant.

10. The system of claim 8, wherein data from multiple data flows within the data object are integrated into the prompt template.

11. The system of claim 8, wherein the prompt template identifiers are specified in an industry-specific package corresponding to the use case and subscribed to by the tenant.

12. The system of claim 8, wherein the processor is further configured to display a prompt template option for a prompt template that is customized for the tenant.

13. The system of claim 8, wherein the processor is further configured to:
display the prompt template options to an additional tenant in a multi-tenant system based on prompt template identifiers contained in an additional data object selected by the tenant;
retrieve the prompt template from a prompt template database based on a selection of one of the prompt template options;
integrate data from the additional data object into the prompt template to produce an additional generative AI prompt; and
obtain an additional output from the generative AI system based on the additional generative AI prompt.

14. The system of claim 8, wherein the prompt template contains instructions for summarizing data contained within two data sources.

15. A non-transitory machine-readable storage medium having instructions stored thereon that, when executed by a set of one or more processors, cause said set of one or more processors to perform operations comprising:
displaying prompt template options to a tenant in a multi-tenant system based on prompt template identifiers contained in a data object selected by the tenant and corresponding to a use case;
retrieving a prompt template from a prompt template database based on a selection of one of the prompt template options;
integrating data from the data object into the prompt template to produce a generative artificial intelligence (AI) prompt; and
obtaining an output from a generative AI system based on the generative AI prompt.

16. The non-transitory machine-readable storage medium of claim 15, the operations further comprising:
displaying the output to a user via a user interface; and
receiving edits to the output from the tenant.

17. The non-transitory machine-readable storage medium of claim 15, wherein the prompt template identifiers are specified in an industry-specific package corresponding to the use case and subscribed to by the tenant.

18. The non-transitory machine-readable storage medium of claim 15, the operations further comprising:
displaying prompt template options to an additional tenant in a multi-tenant system based on prompt template identifiers contained in an additional data object selected by the additional tenant;
retrieving the prompt template from a prompt template database based on a selection of one of the prompt template options;
integrating data from the additional data object into the prompt template to produce an additional generative artificial AI prompt; and
obtaining an additional output from the generative AI system based on the additional generative AI prompt.

19. The non-transitory machine-readable storage medium of claim 15, wherein the prompt template contains instructions for summarizing data contained within two data sources.

20. The non-transitory machine-readable storage medium of claim 15, the operations further comprising displaying a prompt template option for a prompt template that is customized for the tenant.
